(19) United States
(12) Patent Application Publication
(10) Pub. No.: US 2026/0196176 A1
(43) Pub. Date: Jul. 9, 2026

(54) PIXEL DRIVING CIRCUIT, DISPLAY PANEL AND DISPLAY DEVICE

(71) Applicant: HKC CORPORATION LIMITED, SHENZHEN (CN)

(72) Inventors: Bin QIU, SHENZHEN (CN); Lidan YE, SHENZHEN (CN)

(21) Appl. No.: 19/555,745

(22) Filed: Mar. 3, 2026

Related U.S. Application Data
(63) Continuation of application No. PCT/CN2024/115908, filed on Aug. 30, 2024.

(30) Foreign Application Priority Data
Sep. 7, 2023 (CN) 202311151065.1

(51) Int. Cl. G09G 3/3233

(52) U.S. Cl. CPC G09G 3/3233; G09G 2300/0819; G09G 2300/0852; G09G 2300/0857; G09G 2310/0286; G09G 2320/0233; G09G 2330/021

(57) ABSTRACT

A pixel driving circuit, a display panel, and a display device are provided. The pixel driving circuit includes a sub-pixel driving module, a compensation signal terminal, and a compensation module. The sub-pixel driving module includes data a writing unit, a data storage unit, a sub-pixel driving unit, and a light-emitting unit. The compensation module includes a compensation control terminal connected to the scan line, a compensation signal input terminal connected to the compensation signal terminal, a first signal input terminal connected to a first power supply signal line, and a driving signal output terminal connected to the second node. The compensation module is configured to output a driving voltage to the second node to enable a driving current to flow through a light-emitting unit. The driving voltage is adjusted through adjustment of a compensation signal to enable the driving current to be equal to a preset target value.

### CROSS REFERENCE TO RELATED APPLICATIONS

The present disclosure is a continuation of International Patent Application No. PCT/CN2024/115908, filed Aug. 30, 2024, which claims foreign priority to Chinese Patent Application No. 202311151065.1, filed on Sep. 7, 2023, the contents of which are hereby incorporated by reference in its entirety.

### TECHNICAL FIELD

The present disclosure relates to the field of display technologies, and in particular to a pixel driving circuit, a display panel, and a display device.

### BACKGROUND

With the development and advancement of display technologies, Organic Light-Emitting Diode (OLED) devices, compared to Liquid Crystal Display (LCD) devices, have advantages such as no need for a backlight, high contrast ratio, self-luminescence, fast response, wide viewing angle, high brightness, vivid colors, thinness and lightness, suitability for flexible panels, wide operating temperature range, and relatively simple structure and manufacturing process. OLED is thus considered as the next generation of display technology.

Currently, the Active-Matrix OLED (AMOLED) display technology typically uses a storage capacitor to maintain the operation of the driving transistor until the next scanning cycle arrives. Because AMOLED uses a storage capacitor for information storage and performs turn-on and turn-off operations for each pixel, each pixel emits light continuously within one frame period. Compared to the Passive-Matrix OLED (PMOLED) display technology, the AMOLED display technology has lower requirements for the efficiency and stability of luminescent materials and relatively lower power consumption. Therefore, AMOLED is more suitable than PMOLED for manufacturing large-sized, high-resolution display panels.

However, in the large-sized OLED display panel, multiple pixel driving circuits are usually supplied with a power supply voltage by the same power source. The lengths of the power supply routing to pixel driving circuits at different positions are different, resulting in different impedances and different levels of attenuation. This causes the actual power supply voltage applied to each pixel unit to be different, which in turn leads to differences between the driving current flowing through each light-emitting unit and the target driving current, causing problems of brightness non-uniformity and affecting the display effect.

### SUMMARY

A first solution of the present disclosure is to provide a pixel driving circuit. The pixel driving circuit includes: a sub-pixel driving module, including a data writing unit, a data storage unit, a sub-pixel driving unit, and a light-emitting unit; a control terminal of the data writing unit is connected to a scan line, a first terminal of the data writing unit is connected to a data line, and a second terminal of the data writing unit is connected to a first node, a control terminal of the sub-pixel driving unit is connected to the first node, a first terminal of the sub-pixel driving unit is connected to a second node, and a second terminal of the sub-pixel driving unit is connected to a first electrode of the light-emitting unit; a first terminal of the data storage unit is connected to the first node, and a second terminal of the data storage unit is connected to the second node; a second electrode of the light-emitting unit is connected to a second power supply signal line; the pixel driving circuit includes a compensation signal terminal and a compensation module; the compensation module includes a compensation control terminal, a compensation signal input terminal, a first signal input terminal, and a driving signal output terminal; the compensation control terminal is connected to the scan line, the compensation signal input terminal is connected to the compensation signal terminal, the first signal input terminal is connected to a first power supply signal line, and the driving signal output terminal is connected to the second node; the data writing unit and the compensation module are configured to respond to signal control of the scan line, the data writing unit is configured to control an on state or a off state of the control terminal of the sub-pixel driving unit and write a data signal from the data line into the data storage unit; the compensation signal terminal is configured to provide a compensation signal to the compensation module, and the compensation module is configured to process the compensation signal and a first power supply signal provided by the first power supply signal line and output a driving voltage; after the sub-pixel driving unit is turned on, the compensation module is configured to transmit the driving voltage to the second node to enable a driving current to flow through the light-emitting unit; the driving voltage at the second node is adjusted through adjustment of the compensation signal to enable the driving current to be equal to a preset target value.

A second solution of the present disclosure provides a display panel. The display panel includes a plurality of pixel driving circuits, arranged in a matrix, and each of the plurality of pixel driving circuits being any one of the above pixel driving circuits; a plurality of scan lines, each of the plurality of scan lines is disposed between adjacent two rows of the pixel driving circuits of the plurality of pixel driving circuits and extends in a row direction, pixel driving circuits of the plurality of pixel driving circuits in a same row are connected to one corresponding scan line of the plurality of scan lines; a plurality of data lines, each of the plurality of data lines is disposed between adjacent two columns of the pixel driving circuits of the plurality of pixel driving circuits and extends in a column direction, pixel driving circuits of the plurality of pixel driving circuits in a same column are connected to one corresponding data line of the plurality of data lines; a plurality of first power supply signal lines, each of the plurality of first power supply signal lines is disposed between adjacent rows or adjacent columns of pixel driving circuits of the plurality of pixel driving circuits and extending in the row direction or the column direction, each of the plurality of pixel driving circuits is connected to one adjacent first power supply signal line of the plurality of first power supply signal lines; a plurality of compensation lines, each of the plurality of compensation lines corresponds to and is electrically connected one corresponding pixel driving circuit of the plurality of pixel driving circuits, the plurality of compensation lines are configured to provide compensation signals to the plurality of the pixel driving circuits to adjust driving voltages of the plurality of pixel driving circuits, such that each of the driving voltages is equal to a target driving voltage.

A third solution of the present disclosure provides a display device. The display device includes any one of the above display panels, a scan driving module, configured to provide a scan signal to the display panel; and a data driving module, configured to provide a data signal to the display panel.

### BRIEF DESCRIPTION OF THE DRAWINGS

To describe the technical solutions in the embodiments of the present disclosure more clearly, the following briefly introduces the accompanying drawings required for describing the embodiments. Obviously, the accompanying drawings in the following description show merely some embodiments of the present disclosure, and those skilled in the art may acquire other drawings from these accompanying drawings without creative efforts.

FIG. 1 is a schematic structural diagram of a pixel driving circuit according to an embodiment of the related art.

FIG. 2 is a schematic structural diagram of a first embodiment of a pixel driving circuit according to the present disclosure.

FIG. 3 is a schematic structural diagram of a second embodiment of a pixel driving circuit according to the present disclosure.

FIG. 4 is a schematic structural diagram of a third embodiment of a pixel driving circuit according to the present disclosure.

FIG. 5 is a schematic structural diagram of a first embodiment of a display panel according to the present disclosure.

FIG. 6 is a schematic structural diagram of a second embodiment of a display panel according to the present disclosure.

FIG. 7 is a schematic structural diagram of a third embodiment of a display panel according to the present disclosure.

FIG. 8 is a schematic structural diagram of a fourth embodiment of a display panel according to the present disclosure.

FIG. 9 is a schematic structural diagram of a display device according to some embodiments of the present disclosure.

### DETAILED DESCRIPTIONS

The following describes the technical solutions of some embodiments of the present disclosure in detail with reference to the drawings.

In the following description, details such as system structures, interfaces, and technologies are provided for description only and not for limitation, to facilitate a thorough understanding of the present disclosure.

The technical solutions in embodiments of the present disclosure are clearly and completely described in conjunction with the drawings in the embodiments of the present disclosure. It is obvious that the described embodiments are only some embodiments of the present disclosure, and not all embodiments. All other embodiments acquired by those skilled in the art based on the embodiments in the present disclosure without the creative work are all within the scope of the present disclosure.

In the present disclosure, the terms “first,” “second,” and “third” are used for descriptive purposes only and should not be understood as indicating or implying relative importance or implicitly specifying the quantity of the indicated technical features. Thus, features defined by “first,” “second,” or “third” may explicitly or implicitly include at least one such feature. In the description of the present disclosure, “plurality” or “multiple” means at least two, such as two, three, etc., unless otherwise explicitly defined. Directional terms (e.g., upper, down, left, right, front, rear, etc.) in the embodiments of the present disclosure are only configured to explain the relative positional relationships or movements of components in a specific posture (as shown in the drawings). If the specific posture changes, the directional terms will change accordingly. In addition, the terms “include” and “have” and any variations thereof are intended to cover non-exclusive inclusion. For example, a process, a method, a system, a product, or a device that includes a series of operations or units is not limited to the listed operations or units, but optionally also includes operations or units not listed, or optionally includes other operations or units inherent to the process, the method, the product, or the device.

“Embodiment” mentioned in the present disclosure means that specific features, structures, or characteristics described in conjunction with embodiments may be included in at least one embodiment of the present disclosure. Some embodiments including a phrase appearing in various positions in the specification does not necessarily refer to the same embodiment, and are not independents or alternative embodiment that are mutually exclusive with other embodiments. Those skilled in the art explicitly and implicitly understand that the embodiments described in the present disclosure may be combined with other embodiments.

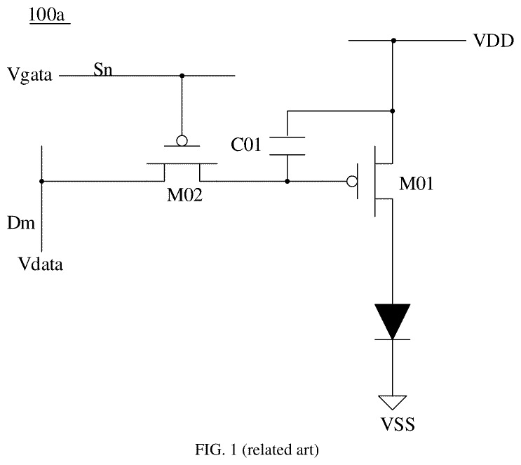

Please refer to FIG. 1. FIG. 1 is a schematic structural diagram of a pixel driving circuit according to an embodiment of the related art. The pixel driving circuit 100a provided in this embodiment is a common 2T1C driving circuit, including a switch transistor M02, a driving transistor M01, and a storage capacitor C01. The working principle is: during the stage when the scan signal Vgate is an effective level, the switch transistor M02 is turned on, and simultaneously the data line Dm inputs a data signal. The data signal Vdata is written into the storage capacitor C01, the driving transistor M01 is controlled to be turned on, and the light-emitting unit emits light. During the stage when the scan signal Vgate is an ineffective level, the storage capacitor C01 discharges, the driving transistor M02 is maintained to be turned on. The VDD signal continuously provides current to the light-emitting unit. The current flowing through the light-emitting unit is controlled by the driving transistor M02, and satisfies the following formula (1):

$${I}_{ds} = 1 / 2 \times W / L \times μ \times C o x \times {( VDD - V data - \vert Vth \vert )}^{2} ; \qquad ( 1 )$$

VDD is the voltage of the constant current source, W is the width of the channel of the driving transistor, L is the length of the channel of the driving transistor, μ is the effective carrier mobility, Cox is the gate insulator layer capacitance per unit area of the driving transistor, Vdata is the data signal input from the data line, and Vth is the threshold voltage of the driving transistor.

W and L are determined during the design of the driving transistor, and Cox is determined by the thickness and material of the gate insulation layer, and these parameters W, L and Cox are fixed. Therefore, the parameters affecting the driving current, i.e., the main variable parameters affecting the brightness of the light-emitting unit are μ, VDD, Vdata, and Vth. Here, μ and Vth are key parameters characterizing the performance of the driving transistor, and VDD and Vdata depend on external inputs.

Currently, since all pixel driving circuits 100a in the panel are connected to the same power source, the path for the VDD signal to reach various levels of pixel driving circuits 100a are different. That is, the routing lengths of the VDD signal lines to various pixel driving circuits 100a are different, resulting in different actual VDD values of different pixel driving circuits 100a. This causes different currents flowing through the OLEDs, ultimately leading to different emission brightness and affecting the display uniformity of the panel.

To solve the above technical problems, some embodiments of the present disclosure provide a pixel driving circuit to solve the above technical problems.

The present disclosure is described in detail below with reference to the drawings and some embodiments.

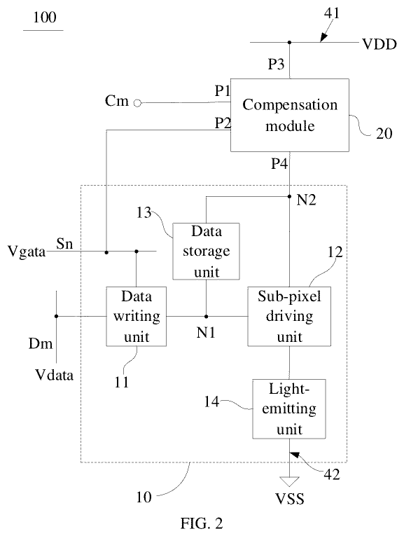

Please refer to FIG. 2. FIG. 2 is a schematic structural diagram of a first embodiment of a pixel driving circuit according to the present disclosure. In this embodiment, a pixel driving circuit 100 is provided. The pixel driving circuit 100 may include a sub-pixel driving module 10, a compensation module 20, and a compensation signal terminal Cm.

The sub-pixel driving module 10 may include a data writing unit 11, a data storage unit 13, a sub-pixel driving unit 12, and a light-emitting unit 14. In the data writing unit 11, a control terminal is connected to a scan line Sn, a first terminal is connected to a data line Dm, and a second terminal is connected to a first node N1. In the sub-pixel driving unit 12, a control terminal is connected to the first node N1, a first terminal is connected to a second node N2, and a second terminal is connected to a first electrode of the light-emitting unit 14. A first terminal and a second terminal of the data storage unit 13 are respectively connected to the first node N1 and the second node N2. A second electrode of the light-emitting unit 14 is connected to a second power supply signal line 42.

The compensation module 20 may include a compensation control terminal P2, a compensation signal input terminal P1, a first signal input terminal P3, and a driving signal output terminal P4. In some embodiments, the compensation control terminal P2 is connected to the scan line Sn, the compensation signal input terminal P1 is connected to the compensation signal terminal Cm, the first signal input terminal P3 is connected to a first power supply signal line 41, and the driving signal output terminal P4 is connected to the second node N2.

When the pixel driving circuit 100 is driven, the scan line Sn provides a scan signal Vgate to the sub-pixel module and the compensation module 20. The data writing unit 11 and the compensation module 20 respond to the signal control of the scan line Sn. The data writing unit 11 controls the on/off state of the control terminal of the sub-pixel driving unit 12 and writes the data signal Vdata from the data line Dm into the data storage unit 13. Simultaneously, the compensation signal from the compensation signal terminal Cm is written into the compensation module 20. The compensation module 20 processes the compensation signal and the first power supply signal provided by the first power supply signal line 41 and outputs a driving voltage. After the sub-pixel driving unit 12 is turned on, the compensation module 20 transmits the driving voltage to the second node N2 to enable a driving current to flow through the light-emitting unit 14, causing the light-emitting unit 14 to emit light. The driving voltage at the second node N2 may be adjusted by adjusting the compensation signal to make the driving current flowing through the light-emitting unit 14 equal to a preset target value.

In this embodiment, the compensation module 20 and the sub-pixel driving module 10 are connected to the same scan line Sn, that is, the compensation module 20 and the sub-pixel driving module 10 are controlled by the same scan signal Vgate, so that the compensation module 20 synchronously provides the driving voltage signal to the sub-pixel driving module 10 during the driving stage of the sub-pixel driving module 10. The scan line Sn provides the scan signal Vgate to the compensation module 20 and the sub-pixel driving module 10. When the scan signal Vgate is an effective level, the data writing unit 11 in the sub-pixel driving module 10 is turned on, and the compensation module 20 is synchronously turned on. The data line Dm provides the data signal Vdata to the data writing unit 11. The data writing unit 11 writes this data signal Vdata into the storage unit and controls the sub-pixel driving unit 12 to be turned on. The compensation signal terminal Cm provides a compensation signal to the compensation module 20. The first power supply signal line 41 provides the first power supply signal to the compensation module 20. After being turned on, the compensation module 20 processes the first power supply signal and the compensation signal and then outputs the driving voltage. The driving voltage is outputted to the second node N2, enabling the driving current to flow through the light-emitting unit 14, causing the light-emitting unit 14 to emit light.

In this embodiment, the first power supply signal is the power supply VDD signal, and the second power supply signal is the power supply VSS signal. In some embodiments, the compensation signal may be adjusted to correspondingly compensate for the driving voltage of the sub-pixel driving module 10, making the driving voltage provided by the compensation module 20 to the sub-pixel driving module 10 equal to the target driving voltage, thereby making the driving current flowing through the light-emitting unit 14 equal to the preset target value. In the display panel 1, the driving voltages of pixel driving circuits 100 at different positions are different due to different lengths of the first power supply signal lines 41, which causes differences in display brightness between different pixels and non-uniform display of the display panel 1. In some embodiments of the present disclosure, the difference between the driving voltage of the pixel driving circuit 100 and the target driving voltage may be compensated through the above configuration, thereby overcoming the deviation in the driving voltage of the pixel driving circuit 100 caused by different lengths of the first power supply signal lines 41, making the display brightness of each pixel unit in the display panel 1 more uniform.

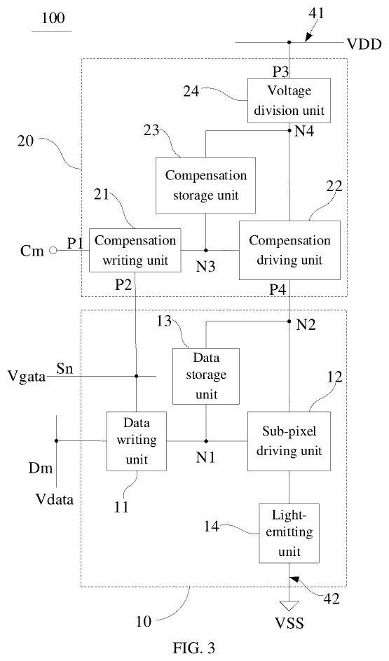

Please refer to FIG. 3. FIG. 3 is a schematic structural diagram of a second embodiment of a pixel driving circuit according to the present disclosure. In this embodiment, the compensation module 20 may include a compensation writing unit 21, a compensation driving unit 22, and a compensation storage unit 23. In the compensation writing unit 21, a control terminal serves as the compensation control terminal P2 and is connected to the scan line Sn, a first terminal serves as the compensation signal input terminal P1 and is connected to the compensation signal terminal Cm, and a second terminal is connected to a third node N3. In the compensation driving unit 22, a control terminal is connected to the third node N3, a first terminal serves as the first signal input terminal P3 and is connected to the first power supply signal line 41, and a second terminal serves as the driving signal output terminal P4 and is connected to the second node N2. A first terminal and a second terminal of the compensation storage unit 23 are respectively connected to the third node N3 and a fourth node N4, the fourth node N4 is disposed between the first power supply signal line 41 and the compensation driving unit 22.

The structure and function of the sub-pixel driving module 10 are the same as or similar to those described in the above embodiment. Please refer to the detailed introduction above.

In some embodiments, during display driving, the scan line Sn provides the scan signal Vgate. During the stage when the scan signal Vgate is an effective level, the compensation writing unit 21 and the data writing unit 11 are turned on. The data line Dm provides the data signal Vdata, and the data writing unit 11 writes the data signal Vdata into the data storage unit 13. The compensation signal terminal Cm provides a compensation signal, and the compensation writing unit 21 writes the compensation signal into the compensation storage unit 23. In the next time period, the compensation writing unit 21 controls the compensation driving unit 22 to be turned on, and the data writing unit 11 controls the sub-pixel driving unit 12 to be turned on. A conductive path is formed between the first power supply signal line 41, the first terminal and second terminal of the compensation driving unit 22, the first terminal and second terminal of the sub-pixel driving unit 12, the light-emitting unit 14, and the second power supply signal line 42, causing the light-emitting unit 14 to emit light. In the next time period, the scan signal Vgate becomes an ineffective level. The compensation writing unit 21 and the data writing unit 11 are turned off. The compensation storage unit 23 discharges, the compensation driving unit 22 is maintained to be turned on. The data storage unit 13 discharges, the sub-pixel driving unit 12 is maintained to be turned on. This allows the first power supply signal to continuously provide driving current to the light-emitting unit 14, maintaining the brightness of the light-emitting unit 14.

In this embodiment, the compensation signal is introduced to compensate for the first power supply signal, making the driving current flowing through the light-emitting unit 14 equal to the preset target value. This avoid the deviation of the first power signal caused by the different lengths of the first power signal lines 41 for the pixel driving circuits 100, which may result in a deviation of the driving current flowing through the light-emitting unit 14 from the preset target value, thereby improving the display uniformity of the display panel 1. Furthermore, in the display panel 1, the lengths of the first power supply signal lines 41 for pixel driving circuits 100 at different positions vary, so that the deviation in driving current from the target value caused also differs. In this embodiment, by adjusting the compensation signal, the first power supply signal of the pixel driving circuit 100 is correspondingly compensated, making the driving current equal to the preset target value, overcoming the above problems and compensating for the brightness difference between different pixel driving circuits 100.

In some embodiments, the compensation module 20 may include a voltage division unit 24. A first terminal of the voltage division unit 24 is connected to the fourth node N4, and a second terminal of the voltage division unit 24 is connected to the first power supply signal line 41. That is, the first signal input terminal P3 is connected to the first power supply signal line 41 through the voltage division unit 24. The voltage division unit 24 is configured to adjust the voltage at the second node N2 and protect the compensation driving unit 22 and the sub-pixel driving unit 12.

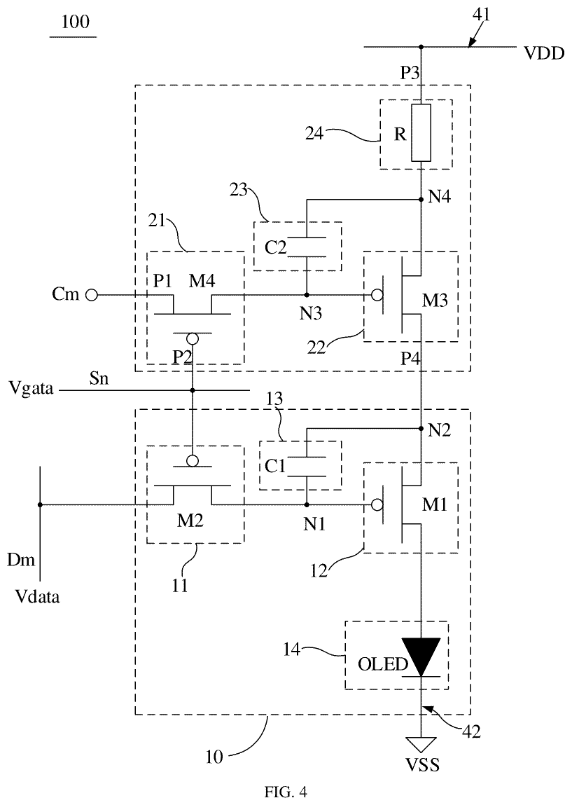

Please refer to FIG. 4. FIG. 4 is a schematic structural diagram of a third embodiment of a pixel driving circuit according to the present disclosure. In this embodiment, the sub-pixel driving unit 12 may include a first driving transistor M1, the compensation driving unit 22 may include a second driving transistor M3, the data writing unit 11 may include a first switch transistor M2, and the compensation writing unit 21 may include a second switch transistor M4. The data storage unit 13 may include a first storage capacitor C1, the compensation storage unit 23 may include a second storage capacitor C2, and the voltage division unit 24 may include a voltage division resistor R. In some embodiments, the first driving transistor M1, the second driving transistor M3, the first switch transistor M2, and the second switch transistor M4 may be thin-film transistors or field-effect transistors. In this embodiment, they are set as metal-oxide-semiconductor field-effect transistors, which may be P-type or N-type according to actual needs. This embodiment uses P-type transistors as an example. In this embodiment, the light-emitting unit 14 is a current-driven light-emitting device, such as a Light-Emitting Diode (LED), Micro LED, Mini LED, or Organic Light-Emitting Diode (OLED), which may be set according to actual needs. Some embodiments of the present disclosure use an (OLED) as an example.

In this embodiment, the second switch transistor M4 and the second driving transistor M3 are switches controlling the first power supply signal. The second storage capacitor C2 is a switch controlling the turn-on of the second driving transistor M3. The second switch transistor M4 is a switch controlling the charging voltage of the second storage capacitor C2. The compensation signal is the compensation data signal Vdata for compensating for the first power supply signal. In some embodiments, the second switch transistor M4 is turned on by the scan signal Vgate. When the scan signal Vgate transitions to an effective level, the first switch transistor M2 and the second switch transistor M4 are turned on. The data line Dm charges the first storage capacitor C1, and the compensation signal terminal Cm charges the second storage capacitor C2. Simultaneously, the first driving transistor M1 and the second driving transistor M3 are turned on. The driving current flows from the first power supply signal line 41 through the voltage division resistor R, the second driving transistor M3, the first driving transistor M1, and the light-emitting unit 14 to the second power supply signal line 42, forming a light-emitting path. The driving current determines the degree of turn-on of the second driving transistor M3, i.e.,

$$VDDm = VDD - Ic \times R - Vth ; \qquad ( 2 )$$

$$Ic = 1 / 2 \times W / L \times μ \times C o x \times {( VDD - Vcm - \vert Vth \vert )}^{2} ; \qquad ( 3 )$$

VDDm is the voltage at the second node N2 of this pixel driving circuit 100, Ic is the driving current, R is the resistance value of the voltage division resistor R, and Vth is the threshold voltage of the second driving transistor M3; Vcm is the compensation voltage of the compensation signal. W, L, μ, Cox, and VDD are the same as described in the previous embodiment and will not be repeated here.

Formula (3) is substituted into formula (2) to get formula (4:)

$$VDDm = VDD - R / 2 \times W / L \times μ \times Cox \times {( VDD - Vcm - \vert Vth \vert )}^{2} - Vth ; \qquad ( 4 )$$

From the above formula (4), the voltage value of VDDm may be acquired. Since VDDs differ in different pixel driving circuits 100, the voltage value VDDm may be adjusted through the value of the compensation voltage Vcm of the compensation signal, so that the voltage values at the second nodes N2 of all pixel driving circuits 100 equal the target driving voltage.

In this embodiment, the compensation signal is introduced to compensate for the first power supply signal of this pixel driving circuit 100, so that the driving voltage of the pixel driving circuit 100 (i.e., the voltage at the second node N2) equals the target driving voltage, thereby making the driving current flowing through the light-emitting unit 14 equal to the preset target value. This avoids the problem of reduced display brightness caused by the deviation between the driving voltage and the target driving voltage due to the power supply voltage drop caused by the first power supply signal lines 41. Furthermore, by adjusting the compensation voltage of the compensation signal, the driving voltage of the pixel circuits may always be maintained to be the target driving voltage, avoiding the problem of reduced brightness caused by circuit aging.

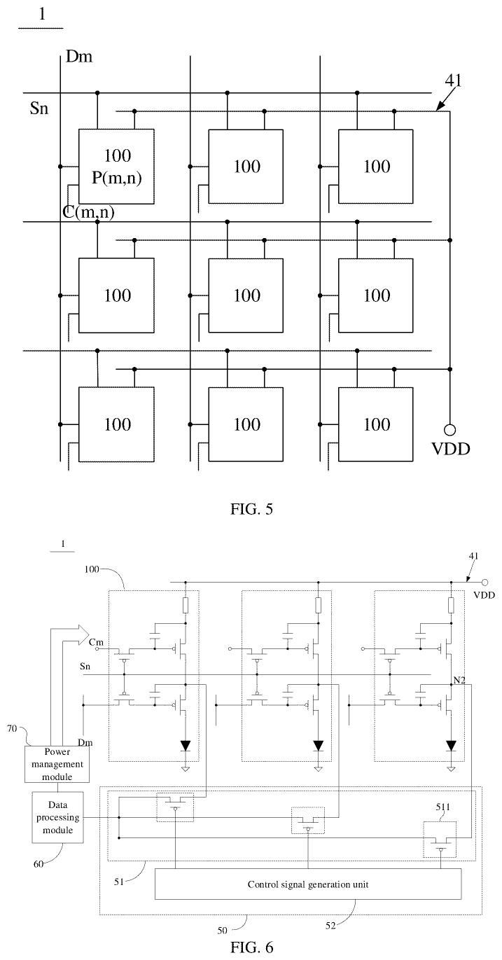

Please refer to FIG. 5. FIG. 5 is a schematic structural diagram of a first embodiment of a display panel according to the present disclosure. In this embodiment, a display panel 1 is provided. The display panel 1 may include a plurality of pixel driving circuits 100, a plurality of scan lines Sn, a plurality of data lines Dm, a plurality of first power supply signal lines 41, and a plurality of compensation lines.

The plurality of pixel driving circuits 100 are arranged in a matrix. The structure and function of each of the pixel driving circuits 100 are the same as or similar to those described in the above embodiments and may achieve the same technical effects. Please refer to the detailed introduction above, which will not be repeated here.

The scan lines Sn are configured to provide scan signals Vgate to the pixel driving circuits 100. The plurality of scan lines Sn are respectively disposed between adjacent two rows of pixel driving circuits 100 and extend in the row direction. Pixel driving circuits 100 in the same row are connected to a correspondingly same scan line Sn.

The data lines Dm are configured to provide data signals Vdata to the pixel driving circuits 100. The plurality of data lines Dm are respectively disposed between adjacent two columns of pixel driving circuits 100 and extend in the column direction. Pixel driving circuits 100 in the same column are connected to a correspondingly same data line Dm.

The first power supply signal lines 41 are configured to provide first power supply signals to the pixel driving circuits 100. The plurality of first power supply signal lines 41 are respectively disposed between adjacent rows or adjacent columns of pixel driving circuits 100 and extend in the row or column direction. Each pixel driving circuit 100 is connected to an adjacent first power supply signal line 41.

Each of the plurality of compensation lines corresponds to one corresponding pixel driving circuit 100 and is electrically connected to the corresponding pixel driving circuit 100, and the plurality of compensation lines are configured to provide compensation signals to the pixel driving circuits 100 to adjust driving voltages of the pixel driving circuits 100, so that the driving voltage of each pixel driving circuit 100 equals the target driving voltage.

In this embodiment, a plurality of compensation lines are introduced in the display panel, and each of plurality of compensation lines corresponds to and electrically connected to one pixel driving circuit 100, so that the driving voltage of each driving circuit 100 is independently compensated, making the driving voltage of each driving circuit equal to the target driving voltage. This makes the brightness of each pixel driving circuit 100 the same, improves the display uniformity of the display panel 1, and avoids the problem of display brightness non-uniformity of the display panel 1 caused by different driving voltages of the pixel driving circuit 100 at different positions due to different power supply voltage drops due to the different lengths of the first power signal lines 41 for the pixel driving circuit 100 at different positions.

Please refer to FIG. 6. FIG. 6 is a schematic structural diagram of a second embodiment of a display panel according to the present disclosure. In this embodiment, the display panel 1 may include a voltage acquisition module 50, a data processing module 60, and a power management module 70.

The voltage acquisition module 50 may include an acquisition control unit 51 and a control signal generation unit 52. The control signal generation unit 52 is connected to a control terminal of the acquisition control unit 51, and an acquisition terminal of the acquisition control unit 51 is connected to the pixel driving circuit 100. The acquisition control unit 51 responds to a control signal from the control signal generation unit 52 to acquire the driving voltages of the pixel driving circuits 100 during a driving stage.

Two ends of the data processing module 60 are respectively connected to an output end of the acquisition control unit 51 and the pixel driving circuits 100. The data processing module 60 is configured to acquire the driving voltages acquired by the acquisition control unit 51, calculate the values of the compensation signals based on the acquired driving voltage, transmit the calculated values of the compensation signals to the power management module 70. The power management module 70 is configured to transmit each of the compensation signals to the corresponding pixel driving circuit 100 through the corresponding compensation line based on the acquired value of the compensation signal, to compensate for the driving voltage of each pixel driving circuit 100.

In some embodiments, as described above, since the first power supply voltages VDD, from the first power supply signal of the pixel driving circuits 100 is different, and when other parameters are the same, according to formula (4) above, the driving voltages VDDm of the pixel driving circuits 100 at different positions are different, where m represents the position of the pixel driving circuit 100. Therefore, the driving voltage VDDm is required to be compensated by the compensation voltage Vcm of the compensation signal.

In this embodiment, during the driving stage of the pixel driving circuit 100, the voltage acquisition module 50 acquires the driving voltage of this pixel driving circuit 100 to acquire the actual value of driving voltage VDDm of this pixel driving circuit 100. The data processing module 60 acquires the acquired actual value of the driving voltage VDDm and performs operational processing based on the actual value of VDDm and the preset value of the first power supply voltage to acquire the compensation voltage corresponding to this pixel driving circuit 100.

In some embodiments, based on formula (4) above, the calculation formula for the compensation signal may be derived as follows:

$$Vcm = VDD - \vert Vth \vert - \sqrt{2 ( VDD - Vth - VDDm ) \cdot \frac{L}{R \cdot W \cdot μ \cdot Cox}} ; \qquad ( 5 )$$

The data processing unit may calculate the required compensation voltage value for this pixel driving circuit 100 according to the above formula (5) and transmit the calculated compensation voltage value to the power management module 70. The power management module 70 outputs the corresponding compensation signal to this pixel driving circuit 100 through the corresponding compensation line based on the compensation voltage value to compensate for the driving voltage of this pixel driving circuit 100.

In some embodiments, during the test development stage or initial display stage of the display panel 1, an initial compensation signal may first be provided to the various levels of pixel driving circuits 100. The initial compensation signal may be calculated according to formula (5) above. VDD is the preset target value of the first power supply signal, the voltage acquisition module 50 may acquire VDDm from the pixel driving circuit 100 with the shortest first power supply signal line 41, and then an initial value of the compensation signal is calculated according to formula (5). This initial compensation signal is then compensated for each pixel driving circuit 100. Subsequently, the actual value of the driving voltage VDDm of each pixel driving circuit 100 is acquired through the voltage acquisition module 50. Based on formula (4), the actual value of the first power supply signal reaching each pixel driving circuit 100 is calculated. Then, according to formula (5), the actual required compensation voltage Vcm for each pixel driving circuit 100 is calculated. This compensation voltage is then compensated for the corresponding pixel driving circuit 100 through the power management module 70, making the driving voltage of each pixel driving circuit 100 reach the target driving voltage, ensuring the driving voltages of all pixel driving circuit 100 are the same, and avoiding driving voltage differences and display differences caused by the different positions of the sub-pixels.

In some embodiments, in the display panel 1, the voltage acquisition module 50 may acquire the driving voltage of each pixel driving circuit 100 and adjust the compensation signals based on the acquired voltage values at regular intervals, so that the driving voltage value of each pixel driving circuit 100 always remains the target driving voltage value.

In some embodiments, since the lengths of the first power supply signal lines 41 for various levels of pixel driving circuits 100 are fixed and do not change over time, the first power supply voltage drop for each pixel driving circuit 100 remains essentially constant. Therefore, after the first detection and compensation, subsequent detection and adjustment of the compensation signal may not be necessary. Thus, during the test development stage of the display panel 1, after the required compensation signals for each pixel driving circuit 100 are acquired through the above detection and compensation method. The compensation signals may then be compensated for the driving voltages of the pixel driving circuits 100 of all sample panels. That is, the display panel 1 after leaving the factory may not include the voltage acquisition module 50 and data processing module 60 to simplify the display panel 1.

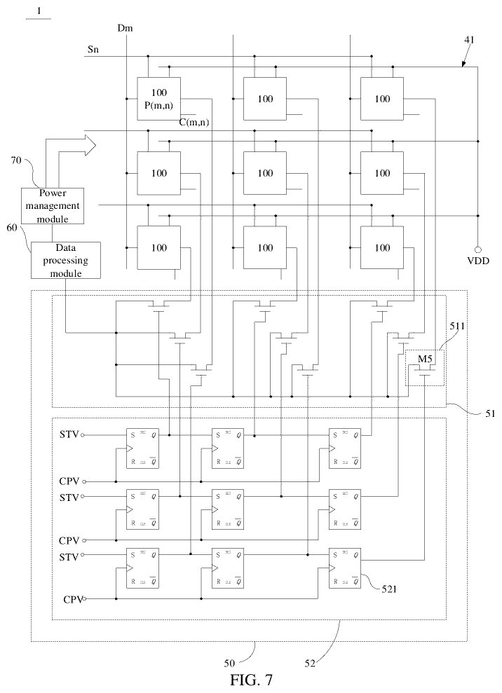

Please refer to FIG. 7. FIG. 7 is a schematic structural diagram of a third embodiment of a display panel according to the present disclosure. In this embodiment, the acquisition control unit 51 may include a plurality of acquisition control sub-units 511. Control terminals of the plurality of acquisition control sub-units 511 are respectively connected to the control signal generation unit 52. A first terminal of each of the plurality of acquisition control sub-units 511 is connected to a corresponding pixel driving circuit 100. The control signal generation unit 52 may include a shift register configured to generate time-division control signals to control the acquisition control sub-units 511 to sequentially acquire the driving voltages of the pixel driving circuits 100 row by row or column by column in a time-division manner.

In some embodiments, each of the acquisition control sub-units 511 may include a third switch transistor M5. A gate of the third switch transistor M5 is connected to a corresponding output end of the shift register. A source of the third switch transistor M5 is connected to the data processing module 60. A drain of the third switch transistor M5 is connected to the second node N2 of the corresponding pixel driving circuit 100.

In some embodiments, the control signal generation unit 52 generates the time-division control signals based on a frame start signal STV and a pulse trigger signal CPV. The frame start signal STV is the same as the frame start signal STV configured to generate the scan signal Vgate, so that when each pixel driving circuit 100 is driven, the first switch transistor M2 and the second driving transistor M3 are turned on, at the same time, the control signal generation unit 52 also controls the corresponding third switch transistor to be turned on. This allows the actual value of the driving voltage at the second node N2 to be acquired during the driving stage of this pixel driving circuit 100, ensuring the accuracy of the acquired driving voltage.

In some embodiments, the control signal generation unit 52 may include a plurality of cascaded D flip-flops 521. The number of the D flip-flops 521 is the same as the number of pixel driving circuits 100. The Q output terminal of each D flip-flop 521 is connected to a control terminal of one corresponding third switch transistor M5, enabling the third switch transistor to be turned on synchronously with the driving of the corresponding pixel driving circuit 100, thereby acquiring the driving voltage of each pixel driving circuit 100.

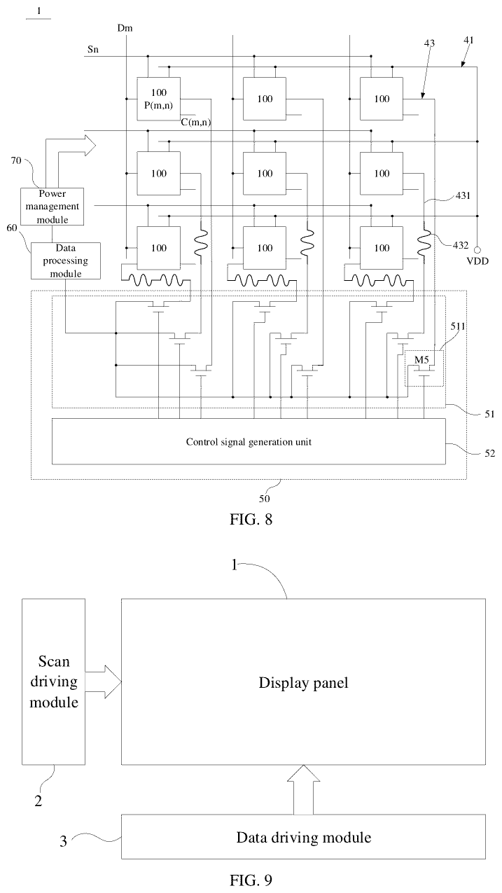

Please refer to FIG. 8. FIG. 8 is a schematic structural diagram of a fourth embodiment of a display panel according to the present disclosure. In the fourth embodiment, the first terminal of each of the acquisition control sub-unit 511 is connected to the second node N2 of the corresponding pixel driving circuit 100. Signal connection lines 43 between some pixel driving circuits 100 and some acquisition control sub-unit 511 have straight-line portions 431 and bent portions 432. Along the direction of the pixel driving circuits 100 approaching the acquisition control unit 51, the total length of the bent portions 432 of the signal connection lines 43 of the pixel driving circuits 100 gradually increases, so that the total length of each signal connection line 43 is the same. For example, the signal connection line 43 extended to the far-end may have no bent portion, while the signal connection line 43 extended to the near-end may have one or more bent portions 432 based on length of the signal connection line 43. The line length of each bent portion 432 may be set based to actual needs. For instance, when the region available for the bent portion is large, the line length of the bent portion 432 may be made long. When the available for the bent portion is limited, the line length of the bent portion 432 may be made short.

Since the voltage detection points for VDDm have differences in distance, signal connection lines between some pixel driving circuits 100 and the corresponding acquisition control sub-units 511 have the bent portions to reduce the influence of the path length. In some embodiments, each of the bent portions may be a serpentine routing. The signal connection line between the detection point at the far-end and the corresponding acquisition control sub-unit 511has no bent portion. Since the distance between the detection point at the near-end and the corresponding acquisition control sub-unit 511 has shorter path length than the distance between the detection point at the far-end and the corresponding acquisition control sub-unit 511, serpentine routing is disposed in a blank region of the panel to increase the path length between the detection point at the near-end and the corresponding acquisition control sub-unit 511. Ultimately, the path length for each detection point is the same, resulting in high accuracy for the detected voltage level.

Please refer to FIG. 9. FIG. 9 is a schematic structural diagram of a display device according to some embodiments of the present disclosure. In this embodiment, a display device is provided. The display device may include a display panel 1, a scan driving module 2, and a data driving module 3.

The structure and function of the display panel 1 are the same as or similar to those described in the above embodiments and may achieve the same technical effects. Please refer to the detailed introduction above, which will not be repeated here.

The scan driving module 2 is electrically connected to the display panel 1 through the scan line Sn and is configured to provide a scan signal Vgate to the display panel 1. The data driving module 3 is electrically connected to the display panel 1 through the data line Dm and is configured to provide a data signal Vdata to the display panel 1, causing the display panel 1 to display a corresponding image.

The above are only some embodiments of the present disclosure, and do not limit the scope of the present disclosure. Any equivalent structural or process transformations made using the content of the specification and drawings of the present disclosure, or direct or indirect applications in other related technical fields, fall within the scope of the present disclosure.

1. A pixel driving circuit, comprising:
a sub-pixel driving module, comprising a data writing unit, a data storage unit, a sub-pixel driving unit, and a light-emitting unit; wherein a control terminal of the data writing unit is connected to a scan line, a first terminal of the data writing unit is connected to a data line, and a second terminal of the data writing unit is connected to a first node, a control terminal of the sub-pixel driving unit is connected to the first node, a first terminal of the sub-pixel driving unit is connected to a second node, and a second terminal of the sub-pixel driving unit is connected to a first electrode of the light-emitting unit; a first terminal of the data storage unit is connected to the first node, and a second terminal of the data storage unit is connected to the second node; a second electrode of the light-emitting unit is connected to a second power supply signal line;
wherein the pixel driving circuit comprises a compensation signal terminal and a compensation module; the compensation module comprises a compensation control terminal, a compensation signal input terminal, a first signal input terminal, and a driving signal output terminal; the compensation control terminal is connected to the scan line, the compensation signal input terminal is connected to the compensation signal terminal, the first signal input terminal is connected to a first power supply signal line, and the driving signal output terminal is connected to the second node;
the data writing unit and the compensation module are configured to respond to signal control of the scan line, the data writing unit is configured to control an on state or a off state of the control terminal of the sub-pixel driving unit and write a data signal from the data line into the data storage unit;
the compensation signal terminal is configured to provide a compensation signal to the compensation module, and the compensation module is configured to process the compensation signal and a first power supply signal provided by the first power supply signal line and output a driving voltage;
after the sub-pixel driving unit is turned on, the compensation module is configured to transmit the driving voltage to the second node to enable a driving current to flow through the light-emitting unit; the driving voltage at the second node is adjusted through adjustment of the compensation signal to enable the driving current to be equal to a preset target value.

2. The pixel driving circuit according to claim 1, wherein the compensation module and the sub-pixel driving module are connected to a same scan line, such that during a driving stage of the sub-pixel driving module, the compensation module synchronously provides the driving voltage to the sub-pixel driving module.

3. The pixel driving circuit according to claim 2, wherein the compensation module comprises a compensation writing unit, a compensation driving unit, and a compensation storage unit; a control terminal of the compensation writing unit serves as the compensation control terminal and is connected to the scan line, a first terminal of the compensation writing unit serves as the compensation signal input terminal and is connected to the compensation signal terminal, and a second terminal of the compensation writing unit is connected to a third node; a control terminal of the compensation driving unit is connected to the third node, a first terminal of the compensation driving unit serves as the first signal input terminal and is connected to the first power supply signal line, and a second terminal of the compensation driving unit serves as the driving signal output terminal and is connected to the second node; a first terminal of the compensation storage unit of the compensation storage unit is connected to the third node, and a second terminal of the compensation storage unit is connected to a fourth node; the fourth node is disposed between the first power supply signal line and the compensation driving unit;
when a signal of the scan line is an effective level, the data writing unit and the compensation writing unit are simultaneously turned on in response to the signal control of the scan line, write the data signal from the data line into the data storage unit, and write the compensation signal provided by the compensation signal terminal into the compensation storage unit; the data writing unit is configured to control the sub-pixel driving unit to be turned on, and the compensation writing unit is configured to control the compensation driving unit to be turned on, such that a driving signal from the first power supply signal line and the compensation signal are outputted to the second node.

4. The pixel driving circuit according to claim 3, wherein when the signal of the scan line becomes an ineffective level, the compensation writing unit and the data writing unit are turned off, the compensation storage unit discharges to maintain the compensation driving unit to be turned on, the data storage unit discharges to maintain the sub-pixel driving unit to be turned on, such that the first power supply signal continuously provides the driving current to the light-emitting unit to maintain brightness of the light-emitting unit.

5. The pixel driving circuit according to claim 3, wherein the compensation module comprises a voltage division unit, a first terminal of the voltage division unit is connected to the fourth node, a second terminal of the voltage division unit is connected to the first power supply signal line, and the voltage division unit is configured to adjust a voltage at the second node.

6. The pixel driving circuit according to claim 5, wherein the sub-pixel driving unit comprises a first driving transistor, the compensation driving unit comprises a second driving transistor, the data writing unit comprises a first switch transistor, the compensation writing unit comprises a second switch transistor; the data storage unit comprises a first storage capacitor, the compensation storage unit comprises a second storage capacitor, and the voltage division unit comprises a voltage division resistor.

7. The pixel driving circuit according to claim 6, wherein the first driving transistor, the second driving transistor, the first switch transistor, and the second switch transistor are thin-film transistors or field-effect transistors; the light-emitting unit is a current-driven light-emitting device.

8. A display panel, comprising:
a plurality of pixel driving circuits, arranged in a matrix;
a plurality of scan lines, wherein each of the plurality of scan lines is disposed between adjacent two rows of the pixel driving circuits of the plurality of pixel driving circuits and extends in a row direction, pixel driving circuits of the plurality of pixel driving circuits in a same row are connected to one corresponding scan line of the plurality of scan lines;
a plurality of data lines, wherein each of the plurality of data lines is disposed between adjacent two columns of the pixel driving circuits of the plurality of pixel driving circuits and extends in a column direction, pixel driving circuits of the plurality of pixel driving circuits in a same column are connected to one corresponding data line of the plurality of data lines;
a plurality of first power supply signal lines, wherein each of the plurality of first power supply signal lines is disposed between adjacent rows or adjacent columns of pixel driving circuits of the plurality of pixel driving circuits and extending in the row direction or the column direction, each of the plurality of pixel driving circuits is connected to one adjacent first power supply signal line of the plurality of first power supply signal lines;
a plurality of compensation lines, wherein each of the plurality of compensation lines corresponds to and is electrically connected one corresponding pixel driving circuit of the plurality of pixel driving circuits, the plurality of compensation lines are configured to provide compensation signals to the plurality of the pixel driving circuits to adjust driving voltages of the plurality of pixel driving circuits, such that each of the driving voltages is equal to a target driving voltage;
wherein each of the plurality of pixel driving circuits comprises:
a sub-pixel driving module, comprising a data writing unit, a data storage unit, a sub-pixel driving unit, and a light-emitting unit; wherein a control terminal of the data writing unit is connected to a scan line, a first terminal of the data writing unit is connected to a data line, and a second terminal of the data writing unit is connected to a first node, a control terminal of the sub-pixel driving unit is connected to the first node, a first terminal of the sub-pixel driving unit is connected to a second node, and a second terminal of the sub-pixel driving unit is connected to a first electrode of the light-emitting unit; a first terminal of the data storage unit is connected to the first node, and a second terminal of the data storage unit is connected to the second node; a second electrode of the light-emitting unit is connected to a second power supply signal line;
wherein the pixel driving circuit comprises a compensation signal terminal and a compensation module; the compensation module comprises a compensation control terminal, a compensation signal input terminal, a first signal input terminal, and a driving signal output terminal; the compensation control terminal is connected to the scan line, the compensation signal input terminal is connected to the compensation signal terminal, the first signal input terminal is connected to a first power supply signal line, and the driving signal output terminal is connected to the second node;
the data writing unit and the compensation module are configured to respond to signal control of the scan line, the data writing unit is configured to control an on state or a off state of the control terminal of the sub-pixel driving unit and write a data signal from the data line into the data storage unit;
the compensation signal terminal is configured to provide a compensation signal to the compensation module, and the compensation module is configured to process the compensation signal and a first power supply signal provided by the first power supply signal line and output a driving voltage;
after the sub-pixel driving unit is turned on, the compensation module is configured to transmit the driving voltage to the second node to enable a driving current to flow through the light-emitting unit; the driving voltage at the second node is adjusted through adjustment of the compensation signal to enable the driving current to be equal to a preset target value.

9. The display panel according to claim 8, further comprising a voltage acquisition module; wherein the voltage acquisition module comprises an acquisition control unit and a control signal generation unit, the control signal generation unit is connected to a control terminal of the acquisition control unit, an acquisition terminal of the acquisition control unit is connected to the plurality of pixel driving circuits;
the acquisition control unit acquires the driving voltages of the plurality of pixel driving circuits during a driving stage in response to a control signal from the control signal generation unit.

10. The display panel according to claim 9, wherein the acquisition control unit comprises a plurality of acquisition control sub-units, a control terminal of each of the plurality of acquisition control sub-units is connected to the control signal generation unit, a first terminal of each of the plurality of acquisition control sub-units is connected to one corresponding pixel driving circuit of the plurality of the pixel driving circuits;
wherein the acquisition control sub-units comprise third switch transistors; and the control signal generation unit comprises a shift register configured to generate a time-division control signal to control the plurality of acquisition control sub-units to sequentially acquire driving voltages of the pixel driving circuits of the plurality of the pixel driving circuits row by row or column by column in a time-division manner.

11. The display panel according to claim 10, wherein the control signal generation unit comprises a plurality of D flip-flops cascaded, a Q output terminal of each of the plurality of D flip-flop is connected to a control terminal of one corresponding third switch transistor of the third switch transistors.

12. The display panel according to claim 10, wherein the control signal generation unit is configured to generate the time-division control signal based on a frame start signal and a pulse trigger signal.

13. The display panel according to claim 9, further comprising a data processing module and a power management module; wherein two ends of the data processing module are respectively connected to an output end of the acquisition control unit and the plurality of pixel driving circuits, the data processing module is configured to acquire the driving voltages acquired by the acquisition control unit, calculate values of the compensation signals based on the acquired driving voltages, and transmit the calculated values of the compensation signals to the power management module; the power management module is configured to transmit each of the compensation signals to a corresponding pixel driving circuit of the plurality of pixel driving circuits based on the acquired values of the compensation signals.

14. The display panel according to claim 13, wherein a gate of each of the third switch transistors is connected to a corresponding output end of the shift register, a source of each of the third switch transistors is connected to the data processing module, and a drain of each of the third switch transistors is connected to a second node of a corresponding pixel driving circuit of the plurality of pixel driving circuits.

15. The display panel according to claim 13, wherein during a test development stage or an initial display stage of the display panel, the display panel is configured to provide initial compensation signals to the plurality of pixel driving circuits through the data processing module and the power management module; after actual values of the driving voltages of the plurality of pixel driving circuits are acquired through the voltage acquisition module, the data processing module calculates compensation voltages based on the actual values of the driving voltages and compensates each of the compensation voltages to one corresponding pixel driving circuit of the plurality of pixel driving circuit through the power management module.

16. The display panel according to claim 15, wherein the voltage acquisition module is configured to acquire the driving voltages of the plurality of pixel driving circuits and adjust the compensation signals based on the acquired driving voltages at regular intervals.

17. The display panel according to claim 10, wherein a first terminal of each of the plurality of acquisition control sub-units is connected to a second node of one corresponding pixel driving circuit of the plurality of pixel driving circuits, signal connection lines between some pixel driving circuits of the plurality of pixel driving circuits and some acquisition control sub-units of the plurality of acquisition control sub-units have straight-line portions and bent portions; along a direction of the plurality of pixel driving circuits approaching the acquisition control unit, a length of one bent portion of bent portions of the signal connection lines close to the acquisition control unit is longer than a length of one bent portion of bent portions signal connection lines away from the acquisition control unit, such that lengths of the signal connection lines are the same.

18. The display panel according to claim 17, wherein each of the bent portions comprises a serpentine routing.

19. A display device, comprising:
a display panel;
a scan driving module, configured to provide a scan signal to the display panel; and
a data driving module, configured to provide a data signal to the display panel;
wherein the display panel comprises:
a plurality of pixel driving circuits, arranged in a matrix;
a plurality of scan lines, wherein each of the plurality of scan lines is disposed between adjacent two rows of the pixel driving circuits of the plurality of pixel driving circuits and extends in a row direction, pixel driving circuits of the plurality of pixel driving circuits in a same row are connected to one corresponding scan line of the plurality of scan lines;
a plurality of data lines, wherein each of the plurality of data lines is disposed between adjacent two columns of the pixel driving circuits of the plurality of pixel driving circuits and extends in a column direction, pixel driving circuits of the plurality of pixel driving circuits in a same column are connected to one corresponding data line of the plurality of data lines;
a plurality of first power supply signal lines, wherein each of the plurality of first power supply signal lines is disposed between adjacent rows or adjacent columns of pixel driving circuits of the plurality of pixel driving circuits and extending in the row direction or the column direction, each of the plurality of pixel driving circuits is connected to one adjacent first power supply signal line of the plurality of first power supply signal lines;
a plurality of compensation lines, wherein each of the plurality of compensation lines corresponds to and is electrically connected one corresponding pixel driving circuit of the plurality of pixel driving circuits, the plurality of compensation lines are configured to provide compensation signals to the plurality of the pixel driving circuits to adjust driving voltages of the plurality of pixel driving circuits, such that each of the driving voltages is equal to a target driving voltage;
wherein each of the plurality of pixel driving circuits comprises:
a sub-pixel driving module, comprising a data writing unit, a data storage unit, a sub-pixel driving unit, and a light-emitting unit; wherein a control terminal of the data writing unit is connected to a scan line, a first terminal of the data writing unit is connected to a data line, and a second terminal of the data writing unit is connected to a first node, a control terminal of the sub-pixel driving unit is connected to the first node, a first terminal of the sub-pixel driving unit is connected to a second node, and a second terminal of the sub-pixel driving unit is connected to a first electrode of the light-emitting unit; a first terminal of the data storage unit is connected to the first node, and a second terminal of the data storage unit is connected to the second node; a second electrode of the light-emitting unit is connected to a second power supply signal line;
wherein the pixel driving circuit comprises a compensation signal terminal and a compensation module; the compensation module comprises a compensation control terminal, a compensation signal input terminal, a first signal input terminal, and a driving signal output terminal; the compensation control terminal is connected to the scan line, the compensation signal input terminal is connected to the compensation signal terminal, the first signal input terminal is connected to a first power supply signal line, and the driving signal output terminal is connected to the second node;
the data writing unit and the compensation module are configured to respond to signal control of the scan line, the data writing unit is configured to control an on state or a off state of the control terminal of the sub-pixel driving unit and write a data signal from the data line into the data storage unit;
the compensation signal terminal is configured to provide a compensation signal to the compensation module, and the compensation module is configured to process the compensation signal and a first power supply signal provided by the first power supply signal line and output a driving voltage;
after the sub-pixel driving unit is turned on, the compensation module is configured to transmit the driving voltage to the second node to enable a driving current to flow through the light-emitting unit; the driving voltage at the second node is adjusted through adjustment of the compensation signal to enable the driving current to be equal to a preset target value.

20. The display device according to claim 19, wherein the compensation module and the sub-pixel driving module are connected to a same scan line, such that during a driving stage of the sub-pixel driving module, the compensation module synchronously provides the driving voltage to the sub-pixel driving module.
